(19) United States
(12) Patent Application Publication
(10) Pub. No.: US 2009/0162173 A1
(43) Pub. Date: Jun. 25, 2009

(54) Warehouse-Lift Arrangement

(76) Inventor: Hartmut Garbers, Bad Homburg (DE)

Correspondence Address: Mark P. Stone, 50 Broadway, Hawthome, NY, 10532, US

(21) Appl. No.: 11/922,359

(22) PCT Filed: Nov. 28, 2006
(86) PCT No.: PCT/EP2006/011372

§ 371 Date: Dec. 12, 2008

(30) Foreign Application Priority Data
Feb. 22, 2006 (DE) 10 2006 008 932.4

(51) Int. Cl. B65G 1/10

(52) U.S. Cl. 414/331.14

(57) ABSTRACT

With a warehouse lift arrangement with two warehouse lifts (1, 2) arranged one behind the other stored-goods carriers (20) can be transferred by a number of vertical conveyors (12, 13, 15) from one warehouse lift to another by means of two pairs of transfer units (16, 17; 18, 19) spaced from one another and arranged one above the other.

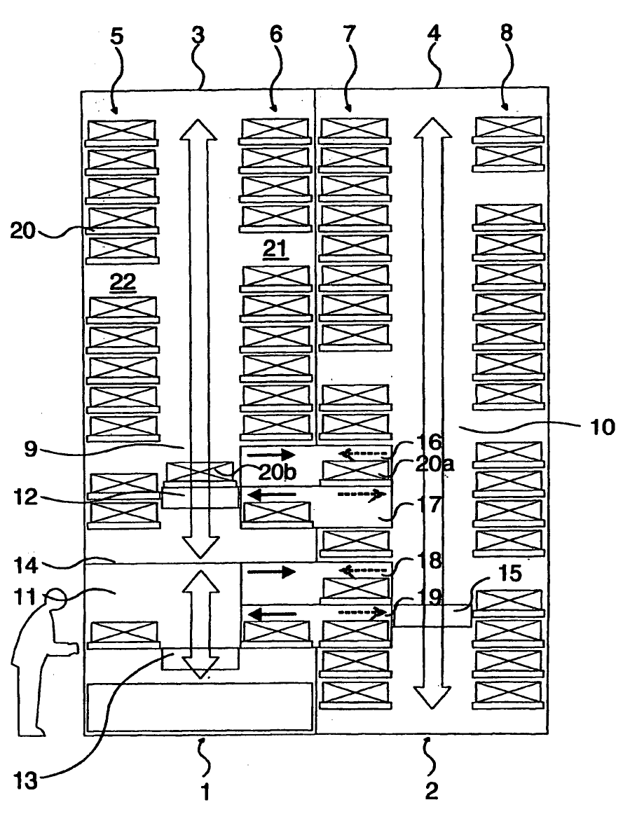

### TECHNICAL FIELD

The invention relates to a warehouse lift arrangement with two warehouse lifts arranged one behind the other, each of which has two oppositely located columns of shelves, which are bordered by shafts, in which vertical conveyors fitted with a horizontal conveying device are arranged, which are used for storing and removing stored-goods carriers in storage locations in the columns of shelves, wherein the front warehouse lift is fitted with a loading and unloading opening and wherein in the rear column of shelves of the front warehouse lift and in the facing front column of shelves of the rear warehouse lift at least one transfer unit is arranged, which facilitates a transfer of stored-goods carriers out of the region of the front warehouse lift into the region of the rear warehouse lift and back again.

### STATE OF THE ART

From the leaflet “Innovation in der Lagerlogistik [Innovation in warehouse logistics]” from Kardex Organisations-Systeme GmbH XPdouble/D/1/3.000/09.05/PD-GWD a warehouse lift of the above type is known, in which in each case a vertical conveyor with a horizontal conveying device can be moved up and down in the shafts present between the respective oppositely located columns of shelves and in which the warehouse lifts are connected together by a transfer unit in order to be able to store goods from the loading and unloading opening of the front warehouse lifts into the rear warehouse lift or to be able to remove goods from the latter. Thus for example, in order to be able to execute a removal process, the vertical conveyor of the rear warehouse lift must first be transported into a position in which a stored-goods transfer can take place onto the transfer unit via its horizontal conveying device. Then a stored-goods transfer can take placed from the transfer unit onto the horizontal conveying device of the vertical conveyor of the front warehouse lift, which to a certain extent forms a bridge to the loading and unloading opening. While the horizontal conveying device of the vertical conveyor of the front warehouse lift is fulfilling its bridging function, it cannot, of course, move to a storage location of this warehouse lift. For the case that the stored-goods carrier located in the region of the loading and unloading opening is to be conveyed back to its old location after a stored-goods removal, the second vertical conveyor is also virtually blocked with the presence of only one transfer unit. The dead time caused by the blockage can be reduced by the procurement of an additional transfer unit which can be used as a buffer. A delay in the loading or unloading processes must however also be accepted in this case. In particular with very high warehouse lifts the outlined circumstances represent a disadvantage insofar as the times which the vertical conveyor of the front warehouse lift remains in the bridging position and which it needs to travel from the loading and unloading opening to a far remote storage location and back sum if directly after the execution of a bridging function, stored-goods are to be stored or removed in the upper region of the front warehouse lift.

### DESCRIPTION OF THE INVENTION

The object of the invention is to shorten the so-called access times for warehouse lift arrangements of the type under consideration, i.e. to keep dead times as short as possible. The object is solved by a generic warehouse lift arrangement according to the invention in that two pairs of transfer units, arranged spaced from one another and one above the other, are used to transfer stored-goods carriers from one warehouse lift to another warehouse lift and in that two vertical conveyors fitted with horizontal conveying devices are provided in the front warehouse lift.

The warehouse-goods arrangement according to the invention offers the advantage that due to the additional vertical conveyor in the front warehouse lift and due to the coupling of the front warehouse lift with the rear warehouse lift via two pairs of transfer units, an uninterrupted supply of the transfer units with stored-goods carriers is possible and the latter can be made available, respectively removed out of one of the transfer units of the lower pair of transfer units in the loading and unloading opening while maintaining short cycle times.

Further features and details of the invention can be taken from the dependent claims and the following description of a particularly suitable warehouse lift arrangement illustrated in the enclosed drawing.

### Methods of Realising the Invention

In the drawing 1 and 2 are two warehouse lifts arranged one behind the other and their principle construction is known. Both warehouse lifts 1 and 2 have a housing 3 respectively 4, in which in each case two oppositely located columns of shelves 5, 6 respectively 7, 8 are arranged with storage locations arranged above each other. The columns of shelves 5 and 6 respectively 7 and 8 border in each case a shaft 9 respectively 10. In the shaft 9 of the warehouse lift 1 fitted with a loading and unloading opening 11 two vertical conveyors 12 and 13 are guided for upward and downward movement, the travel distances of which being limited by an intervening ceiling 14. A third vertical conveyor 15, which can move up and down in the shaft 10, can travel over the complete height of the warehouse lift 2.

The rear column of shelves 6 of the front warehouse lift 1 and the front column of shelves 7 of the rear warehouse lift 2 are linked together by four transfer units 16, 17 and 18, 19 which are arranged one above the other in pairs. With the aid of the transfer units 16 to 19 stored-goods carriers 20 can be transferred from the warehouse lift 1 into the warehouse lift 2 and back. The transfer units 16 to 19 can here be used as buffers into or out of which stored-goods carriers 20 are stored and removed during the loading or unloading of a stored-goods carrier 20 waiting in the loading and unloading opening 11. In other words there is the possibility of using the time during which the vertical conveyor 13 remains in the position illustrated in the drawing in order with the aid of the vertical conveyor 12, for example, to transfer a stored-goods carrier 20a from the storage location 21 and a stored-goods carrier 20b from the storage location 22 into the region of the transfer unit 16, from where they both can then be passed by the vertical conveyor 15 into the region of the transfer unit 19. Lost times, which would be unavoidable with the use of only one vertical conveyor in the warehouse lift 1, are avoided in this way. The vertical conveyor 13, which similarly to the vertical conveyors 12 and 15 is fitted with a horizontal conveying device in a known manner, represents to a certain extent a type of lifting bridge, which on one hand bridges the intervening space between the transfer unit 19 and the loading and unloading opening 11 and on the other hand loads the transfer unit 18 with stored-goods carriers 20 which are to be stored.

The horizontal conveying device of the transfer units 16-19 can be modified as indicated by the opposing arrows.

1. Warehouse lift arrangement with two warehouse lifts (1, 2) arranged one behind the other, which each have two oppositely located columns of shelves (5, 6 respectively 7, 8), which border shafts (9, 10), in which vertical conveyors (13, 15) fitted with a horizontal conveying device are arranged, which are used for storing and removing stored-goods carriers (20) in the storage locations of the columns of shelves (5-8) wherein the front warehouse lift (1) is provided with a loading and unloading opening (11) and wherein in the rear column of shelves (6) of the front warehouse lift (1) and in the front facing column of shelves (7) of the rear warehouse lift (2) at least one transfer unit (19) is arranged, which facilitates the transfer of stored-goods carriers (20) from the region of the front warehouse lift (1) into the region of the rear warehouse lift (2) and back, characterised in that two pairs of transfer units (16, 17; 18, 19) spaced from one another and arranged one above the other are used to transfer stored-goods carriers (20) from one warehouse lift (1) to the other warehouse lift (2) and that two vertical conveyors (12, 13) fitted with horizontal conveying devices are provided in the front warehouse lift (1).

2. Arrangement according to claim 1, characterised in that the travel path of the lower vertical conveyor (13) in the front warehouse lift (1) is limited to the region of the lower pair of transfer units (18, 19).

3. Arrangement according to claim 1, characterised in that the travel path of the upper vertical conveyor (12) of the vertical conveyors (12, 13) arranged in the front warehouse lift (1) is limited to a region above the two lower transfer units (18, 19).

4. Arrangement according to claim 1, characterised in that the transfer units (16-19) can execute transfer movements in opposing directions.

5. Arrangement according to claim 1, characterised in that the stored goods carriers (20) are assigned to fixed locations in the columns of shelves (5-8).

6. Arrangement according to claim 2, characterised in that the travel path of the upper vertical conveyor (12) of the vertical conveyors (12, 13) arranged in the front warehouse lift (1) is limited to a region above the two lower transfer units (18, 19).

7. Arrangement according to claim 6, characterised in that the transfer units (16-19) can execute transfer movements in opposing directions.

8. Arrangement according to claim 6, characterised in that the stored goods carriers (20) are assigned to fixed locations in the columns of shelves (5-8).

9. Arrangement according to claim 2, characterised in that the transfer units (16-19) can execute transfer movements in opposing directions.

10. Arrangement according to claim 3 characterised in that the transfer units (16-19) can execute transfer movements in opposing directions.

11. Arrangement according to claim 2, characterised in that the stored goods carriers (20) are assigned to fixed locations in the columns of shelves (5-8).

12. Arrangement according to claim 3, characterised in that the stored goods carriers (20) are assigned to fixed locations in the columns of shelves (5-8).

13. Arrangement according to claim 4, characterised in that the stored goods carriers (20) are assigned to fixed locations in the columns of shelves (5-8).
